(19) United States
(12) Patent Application Publication
(10) Pub. No.: US 2026/0323066 A1
(43) Pub. Date: Oct. 15, 2026

(54) METHOD AND DEVICE FOR VIDEO CODING USING IMPLICIT NEURAL REPRESENTATION MODEL BASED ON TEMPORAL DEPENDENCY

(71) Applicants: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(72) Inventors: Je Won Kang, Seoul (KR); Jung Kyung Lee, Seoul (KR); Ju Yeon Shin, Seoul (KR); Ji Hoo Lee, Seoul (KR); Jung Ah Choi, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(21) Appl. No.: 19/484,296

(22) PCT Filed: Apr. 15, 2024
(86) PCT No.: PCT/KR2024/095738

§ 371 Date: Nov. 13, 2025

(30) Foreign Application Priority Data
May 17, 2023 (KR) 10-2023-0063866
Apr. 11, 2024 (KR) 10-2024-0048651

(51) Int. Cl. H04N 19/51; H04N 19/137; H04N 19/154; H04N 19/176; H04N 19/42; H04N 19/46

(52) U.S. Cl. CPC H04N 19/51; H04N 19/137; H04N 19/154; H04N 19/176; H04N 19/42; H04N 19/46

(57) ABSTRACT

A method and an apparatus are disclosed for video coding using an implicit neural representation model based on temporal dependency. The video decoding apparatus configures an input to an Implicit Neural Representation for Video Coding model (INRVC model) that includes a current time index of the current image, and obtains the INRVC model that includes a multi-layer perceptron and an upscaling module. The video decoding apparatus generates a multi-layer perceptron output by applying the input to the multi-layer perceptron. The video decoding apparatus predicts motion information between the current image and a previous output of the INRVC model corresponding to a previous time index. The video decoding apparatus generates a current output corresponding to the current time index by inputting the multi-layer perceptron output and the motion information combined to the upscaling module.

### TECHNICAL FIELD

The present disclosure relates to a video coding method and an apparatus using an implicit neural representation model based on temporal dependency.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Recently, deep learning-based image processing techniques have been applied to existing coding element technologies. Among the existing coding technologies, compression techniques such as inter prediction, intra prediction, in-loop filter, transform, or the like may employ deep learning-based image processing techniques to increase coding efficiency. Typical application examples include inter prediction based on a virtual reference frame generated by deep learning, in-loop filter based on a denoising model, and the like.

Meanwhile, there has been recently active research on implicit neural representation models that present images and various data representations in a neural network structure. A conventional video representation scheme in use is an explicit representation scheme with RGB pixel values assigned to each pixel position. To replace such an explicit representation scheme, an implicit neural representation scheme is newly introduced, providing a neural network representation of a function that generates the (r,g,b) value at (x,y) coordinates where image pixels are located. Video coding using the implicit neural representation scheme is called Implicit Neural Representation for Video Coding (INRVC) or implicit neural representation-based video coding. Existing INRVC techniques utilize information on the current video frame exclusively. Therefore, to increase video coding efficiency and enhance video quality, INRVC techniques needs a method of utilizing past video frame information.

### DISCLOSURE

### Technical Problem

The present disclosure seeks to provide a video coding method and an apparatus that, when performing an implicit neural representation-based video coding (Implicit Neural Representation for Video Coding or INRVC), utilize temporal dependencies based on information on the current video frame and a past video frame.

### Technical Solution

At least one aspect of the present disclosure provides a method for reconstructing a current image by a video decoding apparatus. The method includes configuring an input to an Implicit Neural Representation for Video Coding model (INRVC model) that includes a current time index of the current image. The method also includes obtaining the INRVC model that includes a multi-layer perceptron and an upscaling module. The method also includes generating a multi-layer perceptron output by applying the input to the multi-layer perceptron. The method also includes predicting motion information between the current image and a previous output of the INRVC model corresponding to a previous time index. The method also includes generating a current output corresponding to the current time index by inputting the multi-layer perceptron output and the motion information combined to the upscaling module.

Another aspect of the present disclosure provides a method for encoding a current image by a video encoding apparatus. The method includes configuring an input to an Implicit Neural Representation for Video Coding model (INRVC model) that includes a current time index of the current image. The method also includes configuring the INRVC model that includes a multi-layer perceptron and an upscaling module. The method also includes generating a multi-layer perceptron output by applying the input to the multi-layer perceptron. The method also includes predicting motion information between the current image and a previous output of the INRVC model corresponding to a previous time index. The method also includes generating a current output corresponding to the current time index by inputting the multi-layer perceptron output and the motion information combined to the upscaling module.

Yet another aspect of the present disclosure provides a method for providing video data to a video decoding apparatus. The method includes encoding the video data into a bitstream, and transmitting the bitstream to the video decoding apparatus. The encoding of the video data includes configuring an input to an Implicit Neural Representation for Video Coding model (INRVC model) that includes a current time index of a current image. The encoding of the video data also includes configuring the INRVC model that includes a multi-layer perceptron and an upscaling module. The encoding of the video data also includes generating a multi-layer perceptron output by applying the input to the multi-layer perceptron. The encoding of the video data also includes predicting motion information between the current image and a previous output of the INRVC model corresponding to a previous time index. The encoding of the video data also includes generating a current output corresponding to the current time index by inputting the multi-layer perceptron output and the motion information combined to the upscaling module.

### Advantageous Effects

As described above, the present disclosure provides a video coding method and an apparatus that, when performing an implicit neural representation-based video coding, utilize temporal dependencies based on information on the current video frame and a past video frame. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating the operation of a convolution layer.

FIG. 7 is a diagram illustrating a single image super resolution (SISR) network.

FIG. 8 is a diagram illustrating a residual block utilized in SISR.

FIG. 9 is a diagram illustrating a convolutional neural network- (CNN-) based fixed-coefficient in-loop filter.

FIG. 10 is a diagram illustrating a Neural Representations for Videos (NeRV) model.

FIGS. 11A and 11B are diagrams illustrating the concept of a NeRV model according to at least one embodiment of the present disclosure.

FIG. 12 is a diagram illustrating an encoding pipeline of a NeRV model, according to at least one embodiment of the present disclosure.

FIG. 13 is a diagram illustrating a decoding pipeline of a NeRV model, according to at least one embodiment of the present disclosure.

FIG. 14 is a diagram illustrating an Implicit Neural Representation for Video Coding model (INRVC model) which includes an in-loop, according to at least one embodiment of the present disclosure.

FIG. 15 is a diagram illustrating an INRVC model which includes optical flow, according to at least one embodiment of the present disclosure.

FIG. 16 is a diagram illustrating a deformable convolution.

FIG. 17 is a diagram illustrating a block-based INRVC model according to another embodiment of the present disclosure.

FIG. 18 is a diagram illustrating the inter prediction performed by the INRVC model, according to at least one embodiment of the present disclosure.

FIG. 19 is a flowchart of a method of encoding the current block by a video encoding apparatus, according to at least one embodiment of the present disclosure.

FIG. 20 is a flowchart of a method of reconstructing the current block by a video decoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

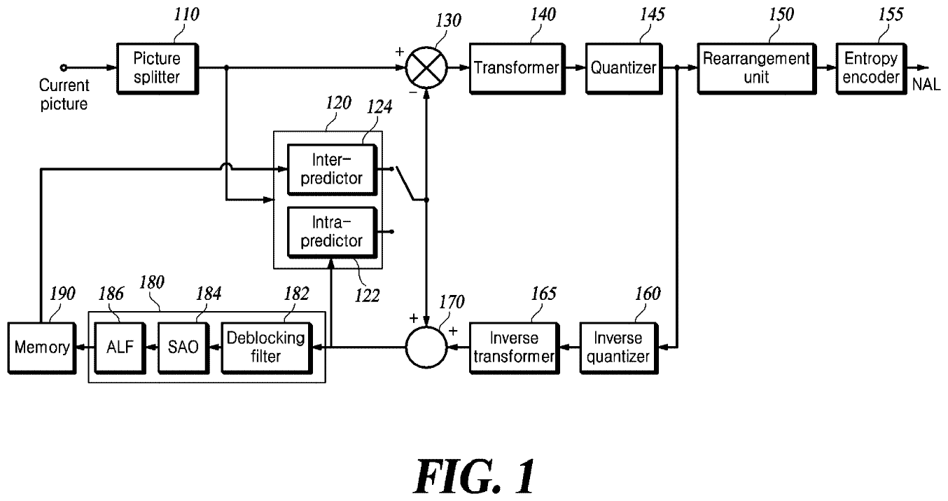

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUS included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

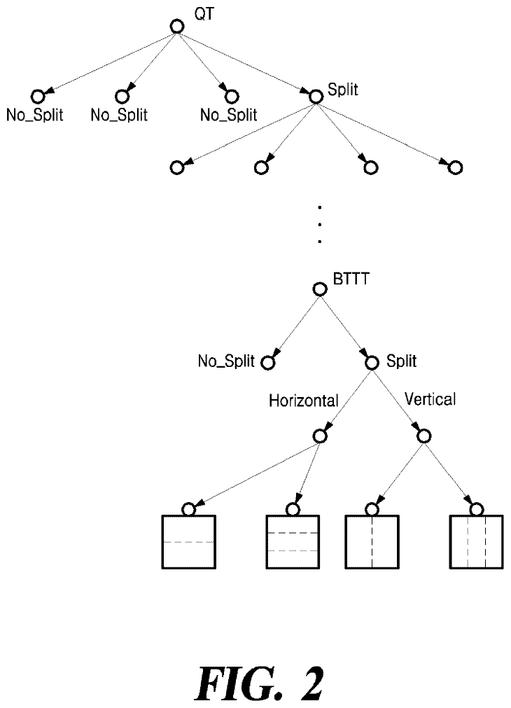

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

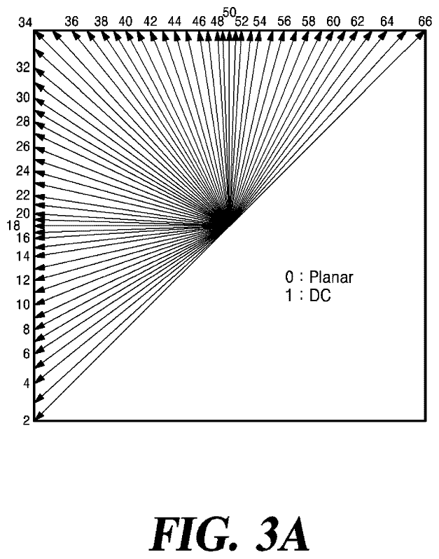

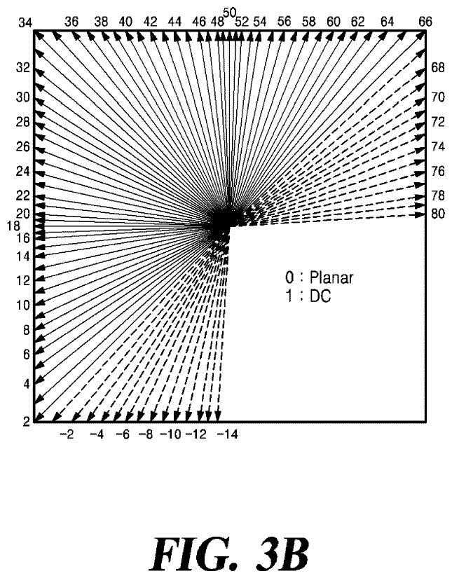

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (intra prediction modes #67 to #80, #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

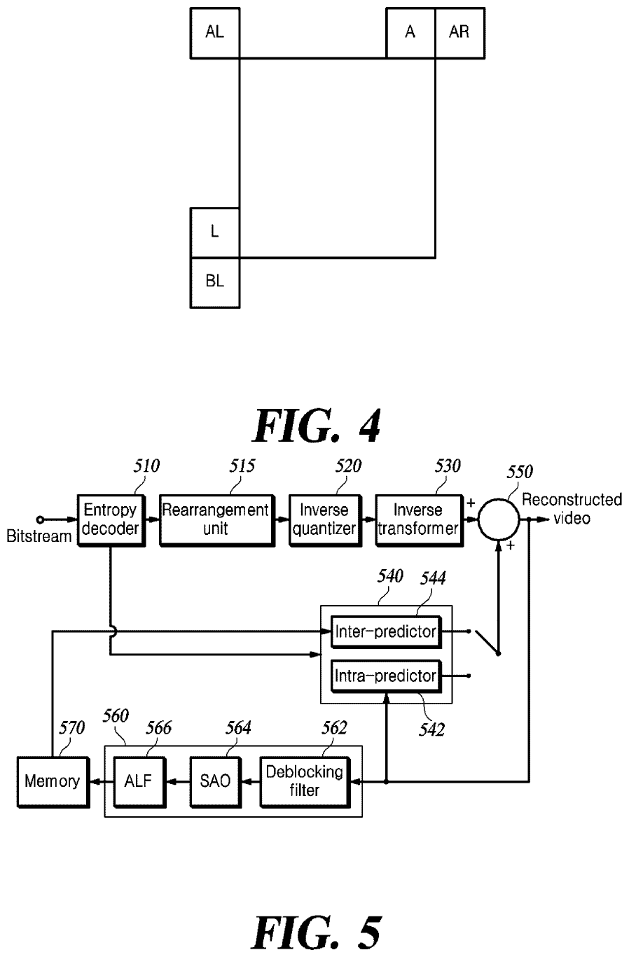

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510, and predicts the current block by using the motion vector and the reference picture.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that, when performing an implicit neural representation-based video coding (Implicit Neural Representation for Video Coding, INRVC), utilize temporal dependencies based on information on the current video frame and a past video frame.

The following embodiments may be performed by a plurality of components in the video encoding device. The following embodiments may also be performed by a plurality of components in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Convolutional Neural Network (CNN)

CNN refers to a neural network composed of a plurality of convolutional layers and pooling layers and is a deep learning technique known to be best suited for image processing. The convolutional layer uses a plurality of kernels or filters to extract a feature map, also referred to as a ‘feature’. The kernel coefficients that constitute the filters are the parameters that are determined during the learning process.

Among the convolutional layers of the CNN, a frontend layer close to the input extracts feature maps that respond to simple, low-level image features such as lines, points, or faces. Among the convolutional layers of the CNN, a backend layer close to the output extracts feature maps that respond to higher-level features such as textures and object parts.

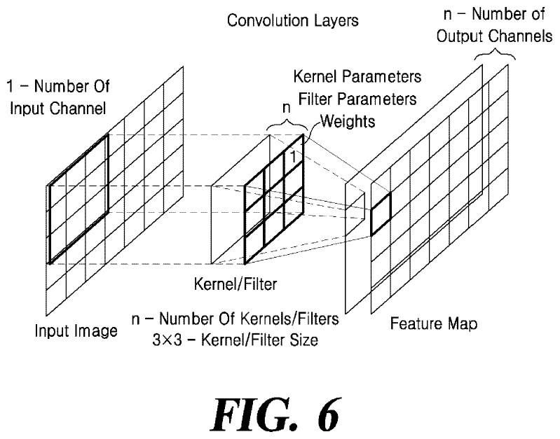

FIG. 6 is a diagram illustrating the operation of a convolutional layer, according to at least one embodiment of the present disclosure.

The convolutional layer utilizes a convolutional operation to generate a feature map from the input image. The example of FIG. 6 depicts a kernel (or filter) with a kernel size of 3×3. The kernel size is also referred to as the filter size. The kernel has a kernel parameter or filter parameter, also referred to as a weight. The kernel illustrated in FIG. 6 has a total of nine kernel parameters. The kernel parameters may be initially set to random values, and their values may be updated based on training.

The convolutional layer performs a convolutional operation by using a block equal to the kernel size in the input image. In this case, the block equivalent to the kernel size in the input image is referred to as a window.

When filtering the input image is performed in a raster-scan order, the amount of the movement of the window is called a stride. In the example of FIG. 6, the stride is 1. If the stride is set to 2, the convolutional operation is performed shifting the window by 2 samples, resulting in the horizontal and vertical dimensions of the feature map being half the horizontal and vertical dimensions of the input image.

As mentioned above, a convolutional layer may include a plurality of filters. The number of filters or the number of kernels is referred to as the number of channels. Namely, the number of channels is equal to the number of filters. The number of filters also determines the dimensionality of the feature map.

Padding refers to a method of expanding the input data by filling in a certain value around the input data before performing a convolutional operation. Padding is often used to control the spatial size of the output data. The value used for padding may be determined by hyperparameters, but zero padding is commonly used. If no padding is used, the spatial size of the output data decreases with each pass through the convolutional layer, which may cause boundary information to be lost. Thus, to avoid this issue, padding is used. Padding can be used to equalize the spatial size of the convolutional layer's output data and input data.

The deconvolutional layer performs the opposite operation of the convolutional layer. The deconvolutional layer generates a desired data image as an output from a feature map which is an input.

The pooling layer performs pooling, which is the process of subsampling the feature map generated by the convolutional layer. The pooling layer utilizes a 2×2 window to select samples such that the output is half the width and half the height of the input. In other words, the pooling layer is utilized to reduce the size of the input image or input feature map by condensing a 2×2 region into a single sample.

The opposite of a pooling layer is defined as an unpooling layer. An unpooling layer serves to increase dimensionality as opposed to a pooling layer and is typically used after a deconvolutional layer.

A convolutional encoder-decoder structure is a network structure composed of pairs of convolutional and deconvolutional layers. A convolutional encoder is composed of a convolutional layer and a pooling layer to output a feature map (or feature vector) from an input image. The final output vector of a convolutional encoder is also referred to as a latent vector. A convolutional decoder is composed of a deconvolutional layer and an unpooling layer to generate an output image from the feature map or latent vector.

The inputs and outputs of the convolutional encoder-decoder may vary depending on the purpose of the application and network. For example, the inputs and outputs may be optical flow maps, saliency maps, image frames, etc.

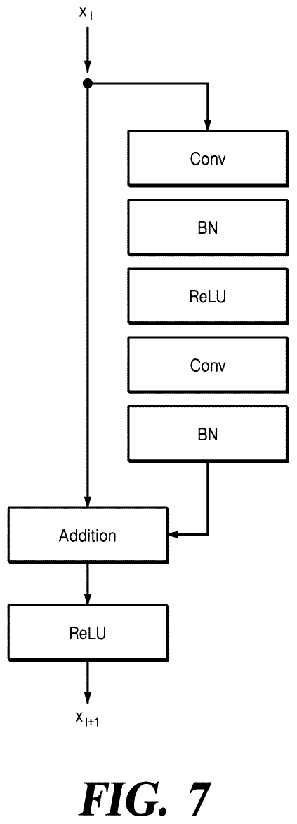

FIG. 7 is a diagram illustrating a SISR network.

One example application of CNN is Single Image Super Resolution (SISR). A SISR network generates a high-resolution output image from a low-resolution input image. A SISR network may include multiple convolutional layers, as illustrated in FIG. 7. Each convolutional layer includes an activation function, such as a Rectified Linear Unit (ReLU). The parameters of the SISR network may be trained such that the resulting super-resolution (SR) image is close to the ground truth (GT).

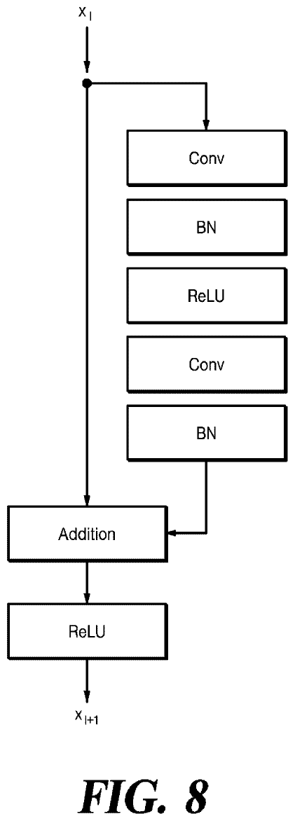

SR methods using CNNs can improve SR performance by increasing the depth, e.g., by increasing the number of convolutional layers. To overcome the problem of overfitting in learning, which may occur with increasing depth, the SISR network may utilize a residual block that may perform skip connections and residual learning. As illustrated in FIG. 8, the residual block includes a skip path in addition to a path for applying a convolutional operation to the input feature x1. In addition, the residual block when generating the output x1+1 may select the path of applying the convolutional operation based on learning efficiency or the skip path. In the example of FIG. 8, the residual block includes a batch normalization (BN) layer.

In one example, Enhanced Deep residual networks for SISR (EDSR) enhance the performance of the network by increasing the depth by concatenating residual blocks in succession. Another example is Accurate Image Super-Resolution Using Very Deep Convolutional Networks (VDSR), a CNN model based on Visual Geometry Group networks (VGG networks) that uses residual learning, which is the addition of residual frames to the final output. VDSR adds the residual signal at the very end of the network and thereby adds the residual signal to the input signal.

As another example, a CNN may be utilized as an in-loop filter in the video encoding apparatus or video decoding apparatus. In this case, the deep learning-based in-loop filter may be employed at any location within the existing loop filter unit 180 or 560 composed of the deblocking filter, the SAO filter, and the ALF.

The deep learning-based in-loop filter may be a fixed coefficient in-loop filter. The fixed coefficient deep learning in-loop filter utilizes the common CNN kernel parameters stored on both sides of the video encoding apparatus and video decoding apparatus.

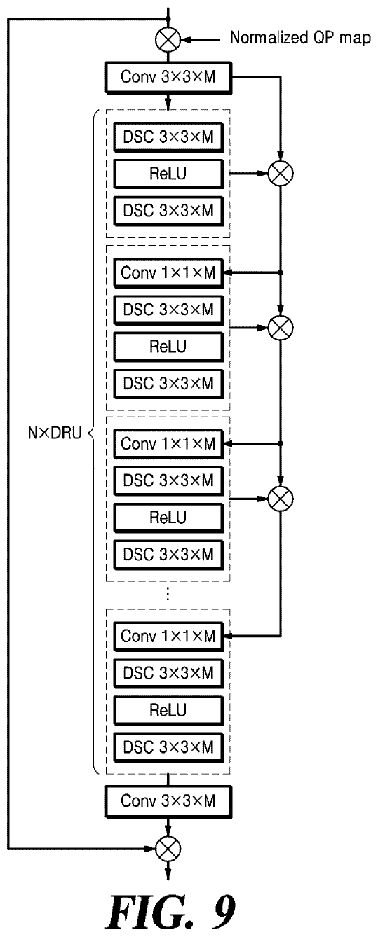

FIG. 9 is a diagram illustrating a CNN-based fixed coefficient in-loop filter.

Input blocks (or input frames) are passed through a normalized QP map and passed to subsequent stages. The normalized QP map is used to reduce inference error when different intensities of quantized noise are mixed in the learning and inference process. The kernel parameters that constitute the dense residual unit (DRU) and convolutional layer may be stored and used identically in the video encoding apparatus and the video decoding apparatus. In the example of FIG. 9, each DRU may include all or part of a convolutional layer, a ReLU layer, and a depth-wise separable convolutional (DSC) layer.

Fixed coefficient deep learning in-loop filters need to provide general performance over a wide range of video frames and therefore they have the disadvantage of increasing the number of layers deep down into the CNN and correspondingly prolonging computation time.

### II. Implicit Neural Representation Model

Recently, there has been active research on implicit neural representation models that represent various data including images in a neural network structure. A conventional video representation scheme used is an explicit representation scheme with RGB pixel values represented for each pixel position. To replace this explicit representation scheme, an implicit neural representation scheme is newly introduced, representing a function by a neural network for converting the (x,y) coordinates of the video pixel position into (r,g,b) values. Compared to the explicit representation scheme, the implicit neural representation scheme can be used regardless of the resolution of the images. Therefore, for the implicit neural representation model, a multi-layer perceptron (MLP) network may be used including multiple fully-connected layers (FC).

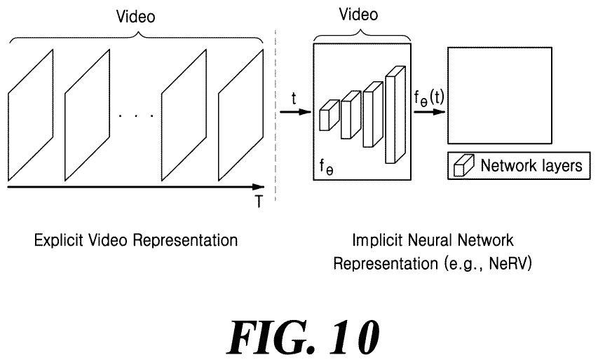

As an example of video coding using implicit neural representation models, there exists implicit neural representation-based video coding (Implicit Neural Representation for Video Coding, INRVC). As mentioned above, the INRVC technique generates (r,g,b) values in respect of the (x,y) coordinates representing pixel positions in an image. As an example INRVC technique, the Neural Representation for Video model (NeRV model) exists. As mentioned above, the explicit representation scheme represents pixel values on an (x,y,t) grid by using the pixel position (x,y) in the image and the time index t of the frame. The implicit neural representation model outputs RGB pixel values from an input representing the position in (x,y,t). However, training a neural network at every position in (x,y,t) can significantly increase the computational complexity, so the NeRV model outputs the RGB image of the entire frame at time index t by using a neural network structure with only time index t used as input, as illustrated in FIG. 10.

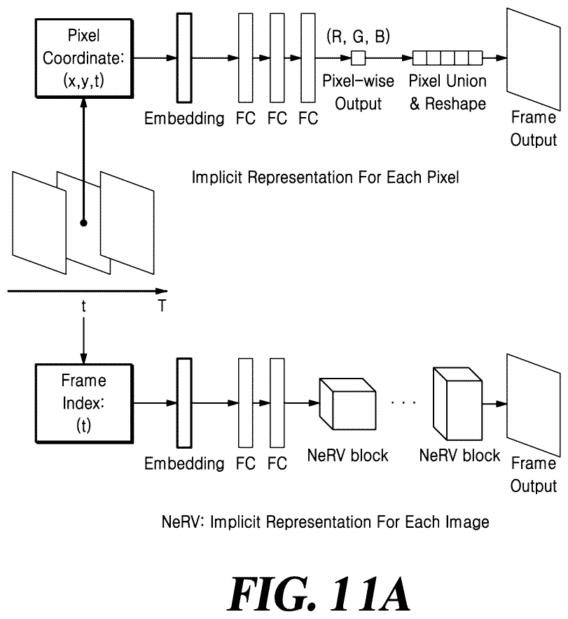

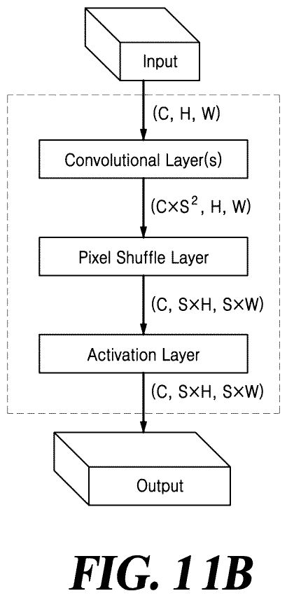

FIGS. 11A and 11B are diagrams illustrating the concept of a NeRV model according to at least one embodiment of the present disclosure.

To facilitate providing image output for a time index t input, utilizing convolutional layers can be more effective than to utilize the existing implicit representation model's MLP (Multi-layer Perceptron) networks. The NeRV model may utilize a stacked structure of NeRV blocks composed of multiple convolutional layers to generate output. As illustrated in FIG. 11A, an MLP-based output and a NeRV block-based output may be compared. The NeRV block includes convolution layers performing convolutions, a pixel shuffle layer, and an activation layer, as illustrated in FIG. 11B. In the example of FIG. 11B, C denotes the number of channels, W and H denote the width and height of the input of the NeRV block, and S denotes the upscaling factor.

Further, the NeRV model embeds time index t into a higher dimensional space and uses the embedded index as an input, as shown in Equation 1.

γ(t)=(sin(2⁰πmt), cos(2⁰πt), . . . , sin(2^{L-1}πt), cos(2^{L-1}πt)) [Equation 1]

As illustrated in Equation 1, time index t may be mapped to a 2 L-dimensional vector γ(t). By utilizing the embedded time index t in the training of the NeRV model, the NeRV model can better predict video data containing high-frequency variations.

As a loss function of the NeRV model, a combination of L1 loss and a structural similarity index loss (SSIM loss) may be used. During training of the NeRV model, these losses may be calculated at all pixel locations in the image estimated by the NeRV model based on the input and in the ground-truth (GT) image, i.e., the original image. The L1 loss is calculated by using the absolute value of the difference between the pixels in the estimated image and the GT image. The SSIM loss is calculated based on the mean, standard deviation, and correlation of the pixels in the estimated image and the GT image. Based on the calculated losses and during the training process, the weights (or parameters) that constitute the NeRV model may then be updated.

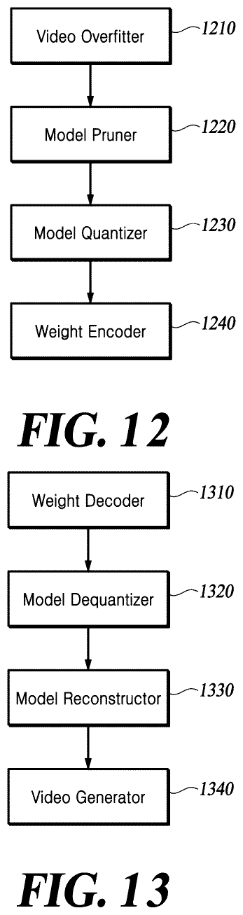

FIG. 12 is a diagram illustrating an encoding pipeline of a NeRV model, according to at least one embodiment of the present disclosure.

Since the NeRV model may be used to approximate the original video, compressing and transmitting the NeRV model can implement end-to-end compression techniques using neural networks. An encoding pipeline for encoding the NeRV model may include all or part of a video overfitter 1210, a model pruner 1220, a model quantizer 1230, and a weight encoder 1240, as illustrated in FIG. 12.

The video overfitter 1210 represents the input video frames by the NeRV model. The video encoding apparatus trains the NeRV model by using the loss function described above to cause the NeRV model to represent the video frame. The model pruner 1220 uses pruning to simplify the NeRV model structure which may be an MLP (multi-layer perceptron) or a mixture of the MLP and convolutional layers. For example, pruning sets weights smaller than a preset threshold to zero. The model quantizer 1230 quantizes the pruned weights, e.g., weights greater than or equal to the threshold. The weight encoder 1240 applies entropy encoding to the quantized weights to generate a bitstream of weights.

A reverse order of the encoding pipeline illustrated in FIG. 12, the decoding pipeline for decoding the NeRV model may be illustrated as in FIG. 13. The decoding pipeline may include all or part of a weight decoder 1310, a model dequantizer 1320, a model reconstructor 1330, and a video generator 1340, as illustrated in FIG. 13.

The weight decoder 1310 applies entropy encoding to the bitstream of weights of the NeRV model to generate quantized weights. The model dequantizer 1320 de-quantizes the quantized weights to generate pruned weights. The model reconstructor 1330 reconstructs the NeRV model based on the pruned weights. The video generator 1340 uses the reconstructed NeRV model according to the time index to generate reconstructed video frames.

As described above, the NeRV model utilizes the time index t of a frame as input. Thus, with a video inputted having pixels of size t×h×w, the NeRV model samples the input video only t times instead of t×h×w times, which may result in significant gains in both encoding and decoding speed.

As described above, the existing INRVC technology utilizes the information of the current frame exclusively, resulting in a limited intra-frame or inter-frame spatial information amount available for use during the output calculation process. Against this issue, an INRVC model solution is described that increases the coding efficiency for the current frame by utilizing the encoding information of past frames that have already completed encoding.

The following embodiments are described with a focus on the video decoding apparatus incorporating the INRVC model, however, they may be implemented identically or similarly in the video encoding apparatus incorporating the INRVC model.

### III. Embodiments According to the Present Disclosure

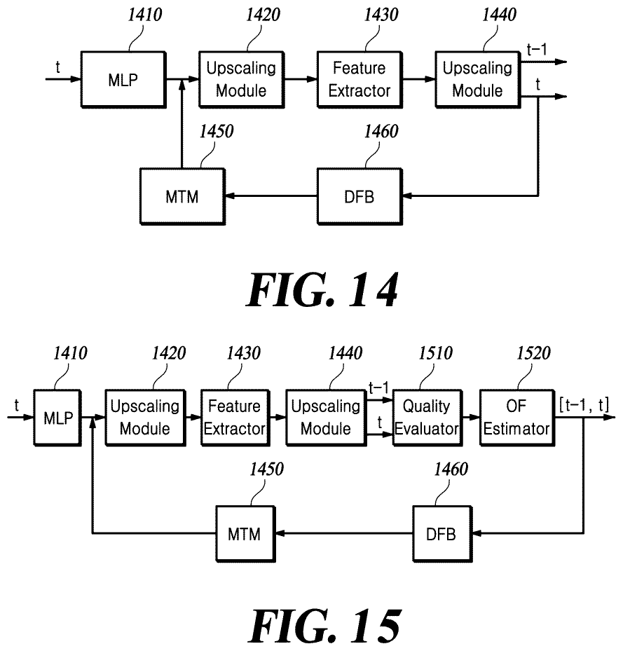

FIG. 14 is a diagram illustrating an INRVC model which includes an in-loop, according to at least one embodiment of the present disclosure.

The INRVC model according to the present disclosure in some embodiments include an in-loop that, when predicting the frame in respect of a current time index t, feeds back the output corresponding to the previous time index t−1. In the example of FIG. 14, an MLP 1410, an upscaling module 1420, a feature extractor 1430, and another upscaling module 1440 constitute the conventional INRVC model. As described above, the conventional INRVC model uses the input of time index t to output the current frame. The upscaling modules 1420 and 1440 include the convolutional layer illustrated in FIG. 6 and the pixel shuffle layer included in FIG. 11B, and use the convolutional layer and the pixel shuffle layer combined to upscale the input. The MLP 1410 and upscaling modules 1420 and 1440 construct an implicit neural representation in respect of the current frame. The feature extractor 1430 generates spatiotemporal information in respect of the input features. The feature extractor 1430 is trained with previous t−1 feature information and current t feature information to generate spatiotemporal information in respect of the current t feature.

The in-loop includes a motion transfer module (MTM) 1450 and a decoded feature buffer (DFB) 1460 as components. The DFB 1460 is included in the memory 570 and stores feature information of past frames. Since the INRVC model utilizes feature information to generate frames, feature information of the frames may be stored in the DFB 1460. Therefore, the INRVC model according to some embodiments may utilize information in respect of other time indices for coding the current frame without requiring additional input. To efficiently utilize the previous t−1 feature information, the MTM 1450 generates an embedding in respect of the previous t−1 feature information, thereby reducing the size of the previous t−1 feature information. The MTM 1450 improves training efficiency at the current time t based on the implicit neural representation by performing motion information prediction and motion compensation between the previous t−1 feature information and the current t feature information. For example, the motion information may include pixel-wise motion constituting an image. The embedding generated by MTM 1450 is generated to conform to the characteristics of the output of the MLP 1410 and is concatenated with the output of the MLP 1410.

The INRVC model uses the in-loop components to generate outputs in respect of the tth and t−1st time indices. Since the output in respect of the t−1st time index has been already stored in the DFB 1460, this output is a bypass-type output and may be utilized to improve the subsequent output in respect of the tth time index.

For example, the MTM 1450 may be implemented as a deep learning model. Then, the INRVC model, which includes the in-loop, may be pre-trained.

The following describes methods of the INRVC model using the MTM 1450 to perform motion prediction and compensation.

Since video input is used to the INRVC model, temporal information, in addition to spatial information, affects model performance. Conventional NeRV extracts only one frame per time index, generating each frame separately, and thus does not take account of temporal information.

As one example, to incorporate temporal information, the feature extraction process outputs both the current and previous frames. The INRVC model may then utilize temporal dependency based on the optical flow between these two frames. As illustrated in FIG. 15, the INRVC model uses an optical flow estimator or OF estimator 1520 to compute the optical flow in respect of the two frames and utilizes the computed optical flow to improve the output in respect of the tth and t−1st time indices. The optical flow may be a pixel-wise motion vector representing the motion of pixels occurring between the t-th picture and the t−1st picture.

At this point, when the quality of the frame outputted from the upscaling modules is low, accurate optical flow is hardly predicted. The INRVC model uses a quality evaluator 1510 to measure the quality of the output previously generated by the upscaling modules, specifically the output in respect of the t−1st time index. When the quality of the output in respect of the t−1st time index is equal to, or above, a preset threshold, the INRVC device calculates the optical flow to improve the outputs in respect of the tth and t−1st time indices. When the quality of the output in respect of the t−1st time index is below the preset threshold, the optical flow calculation process is skipped, and the output generated by the upscaling modules is used as the final output.

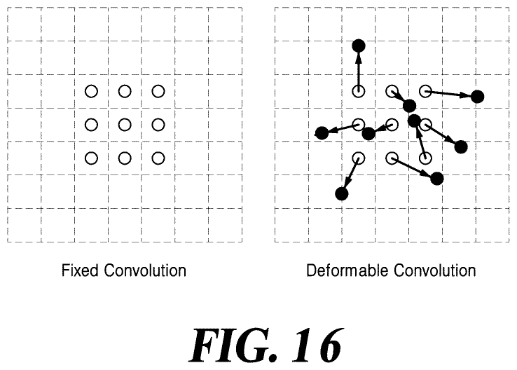

As another example, the INRVC model may include a deformable convolution module and may use a deformable convolution to generate temporal information between features. The deformable convolution module may replace the quality evaluator 1510 and the OF estimator 1520. The deformable convolution may extract features from a fixed kernel, e.g., the 3×3 kernel shown on the left side of FIG. 16, and besides, and may extract features from a more flexible region, as illustrated on the right side of FIG. 16. The deformable convolution module generates offsets based on feature information at different time points and uses these offsets to adaptively adjust the size of the convolution kernel. The deformable convolution module uses the adjusted kernel to effectively generate relationships between features with different temporal information. The INRVC model may be trained for the deformable convolution model to generate offsets and generate temporal information between features. Generating offsets based on outputs of the up-scaling modules as illustrated in FIG. 15, adjusting the kernel size by using these offsets, and causing the adjusted kernel to generate features and using a temporal dependency between the generated features can allow the INRVC model to predict motion between frames.

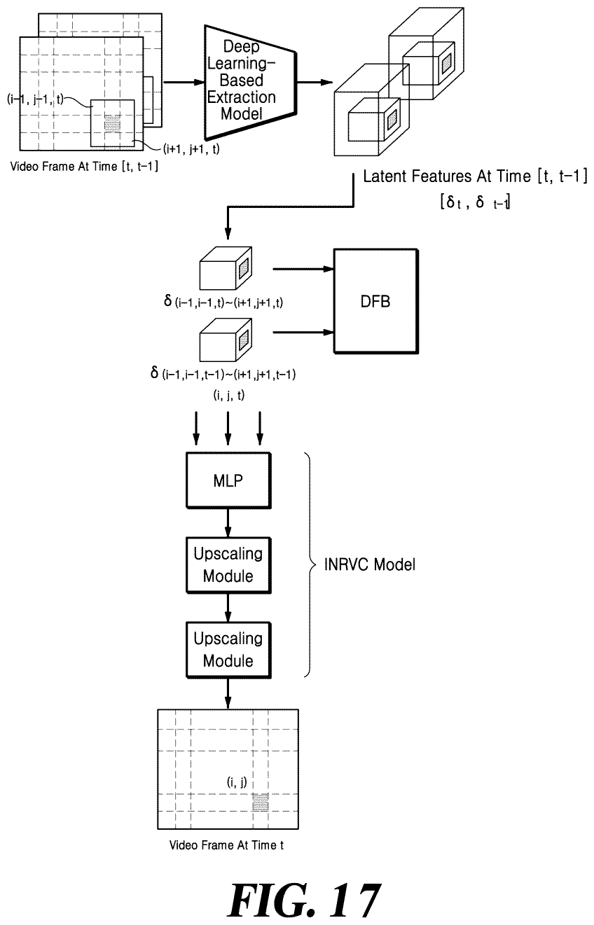

For example, the INVRC model may utilize the features of spatio-temporally adjacent blocks, as illustrated in the example of FIG. 17. The NeRV model is an INRVC model that receives an input of time index t, and an extended version of the NeRV model according to the present disclosure may use the block index (i, j) of the coding tree unit (CTU) or CU for training. By extracting block signal information by using this block index, the INVRC model can be applied more effectively to existing coding devices. Here, the CTU and CU indicated by the block index represent the current CTU and current block, respectively. For convenience of description, the term “block” hereafter refers to the current block.

The example of FIG. 17 uses as input to the INVRC model the block index (i, j) and time index t and additional local features containing spatiotemporal information of video frames. Here, the local features are extracted from the video frames by a deep learning-based extraction model. As local features, latent features are used that include the features of the (i, j)th block or the features of spatio-temporally adjacent blocks. For example, a spatio-temporally adjacent block is one that has already completed decoding, representing samples of a block located to the left or above the current block in intra prediction. In inter prediction, a neighboring block refers to a block within a preceding frame in the decoding sequence. In the example of FIG. 17, as input, the INVRC model additionally utilizes local features (δₜ, δₜ₋₁) which are the combined features of the (i, j)th block and its spatio-temporally adjacent blocks.

For example, the video encoding apparatus trains the extraction model and the block-based INVRC model end-to-end as illustrated in FIG. 17, enabling the extraction model to extract local features and enabling the INVRC model to represent blocks. The video encoding apparatus uses the above-described encoding pipeline to transmit the block-based INVRC model to the video decoding apparatus. Additionally, the video encoding apparatus encodes local features associated with the block and transmits the encoded local features to the video decoding apparatus. The video decoding apparatus uses the above-described decoding pipeline to reconstruct the block-based INVRC model. Additionally, the video decoding apparatus decodes the local features. Subsequently, the video decoding apparatus inputs the block index, time index, and local features into the block-based INVRC model to reconstruct the block corresponding to the block index.

The video encoding apparatus follows the NeRV method to encode the INVRC model according to an encoding pipeline, such as the example in FIG. 12, and then transmits the encoded model to the video decoding apparatus. The trained INVRC model complete with the training is encoded by reducing its size through model pruning, quantization, and entropy encoding applied thereto. The quantization process may select a quantization method based on post-training quantization or training with quantization considered. The video decoding apparatus reconstructs the INVRC model according to a video decoding pipeline, such as the example in FIG. 13. The INVRC model may be implemented by using either a floating-point operation method or a fixed-point operation method using model parameters of N bits, e.g., 8, 16, 32 bits, or the like, considering its versatility for heterogeneous devices such as central processing units (CPUs) and graphic processing units (GPUS).

Meanwhile, local features extracted by the video encoding apparatus or decoded by the video decoding apparatus are stored in the DFB 1460. Since local features may be inputted to the MTM 1450, the (i, j)th block generated by the INVRC model may not be stored in the DFB 1460. Meanwhile, the INVRC model may reference the features of a number N of spatially adjacent blocks and the features of a number M of temporally adjacent blocks. When reconstructing the (i, j)th block, used as inputs are the features of the N spatially adjacent blocks, the features of the M temporally adjacent blocks, and the block time index (i, j, t). Here, N and M are selected according to one of the following methods.

For example, as illustrated FIG. 17, adjacent blocks may be referenced in a cubic form. For example, spatially adjacent blocks [i−N/2, j−N/2] to [i+N/2, j+N/2] and temporally adjacent blocks [i−M/2, j−M/2] to [i+M/2, j+M/2] may be referenced.

As another example, adjacent blocks in a cross or diamond shape among other predefined arbitrary shapes may be referenced.

Yet another example measures the similarity between the (i, j) block and spatially and/or temporally adjacent blocks defined as described above, extracts K candidate blocks in order of similarity starting with the most similar block and thereby references the extracted K candidate blocks in that order.

In intra prediction, some or all samples of blocks located to the left, top, top-left, bottom-left, or top-right of the current block may be referenced. In inter prediction, samples in frames preceding the current frame in the decoding order may be referenced.

The following describes the temporal dependency-based INRVC model combined with the existing video coding techniques.

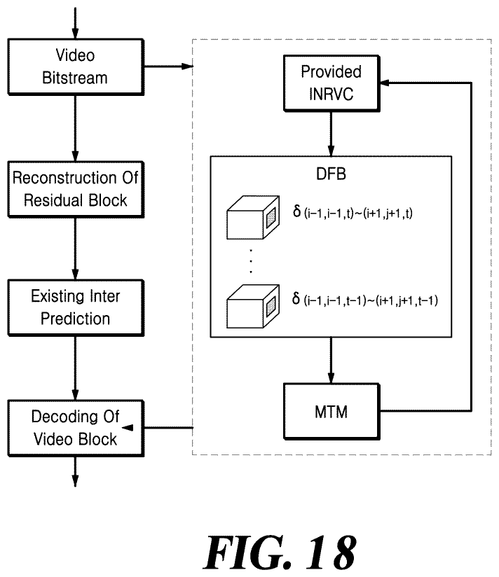

FIG. 18 is a diagram illustrating the inter prediction performed by the INRVC model, according to at least one embodiment of the present disclosure.

For example, the temporal dependency-based INRVC model performs block-wise inter prediction as follows. In a conventional predicting/decoding process, the video decoding apparatus decodes the residual block and adds it to the prediction block to generate the reconstructed block of the current block. In place of the conventional method, the INRVC model constructs input signals by combining the time index and block index of the block or frame to be decoded. It then outputs from these input signals a video block at the corresponding temporal and spatial location to generate the reconstructed block of the current block. At this time, as illustrated in FIG. 18, local features stored in the DFB 1460 may be used for predicting motion information. Here, the motion information may be that of the current block. The video encoding apparatus compares the existing mode and the INRVC mode in terms of rate-distortion optimization, selects the mode providing better coding efficiency, and explicitly signals the selected mode at a predetermined block level of CTU, CU, picture unit, transform unit, or the like. Hereafter, the flag indicating the utilization of the INRVC mode is referred to as the INRVC utilization flag. The video decoding apparatus, as illustrated in FIG. 18, is responsive to the parsed flag by decoding the bitstream indicating the use of the INRVC mode, for using the INRVC model in place of the conventional mode.

In the example of FIG. 18, the video decoding apparatus selects local features of spatio-temporally adjacent blocks in the DFB (decoded feature buffer) 1460 to utilize the INVRC model. The video decoding apparatus performs motion prediction by using the MTM (motion transfer module) 1450 based on the selected local features for motion prediction and compensation which are correct as of current time t and thereby generates the current feature and block, consequently, the frame. The video decoding apparatus performs decoding of the video block by utilizing both the video frame decoded according to conventional video coding technology and the frame generated by using the INVRC model.

The present disclosure describes the INRVC model compressing and reconstructing video frames arranged in the order of time index t, but it is not necessarily limited thereto. The INRVC model may be applied to process video frames arranged in an arbitrary sequence. For example, the INRVC model may be applied to compress and reconstruct multi-view video frames arranged in the order of viewpoint index v.

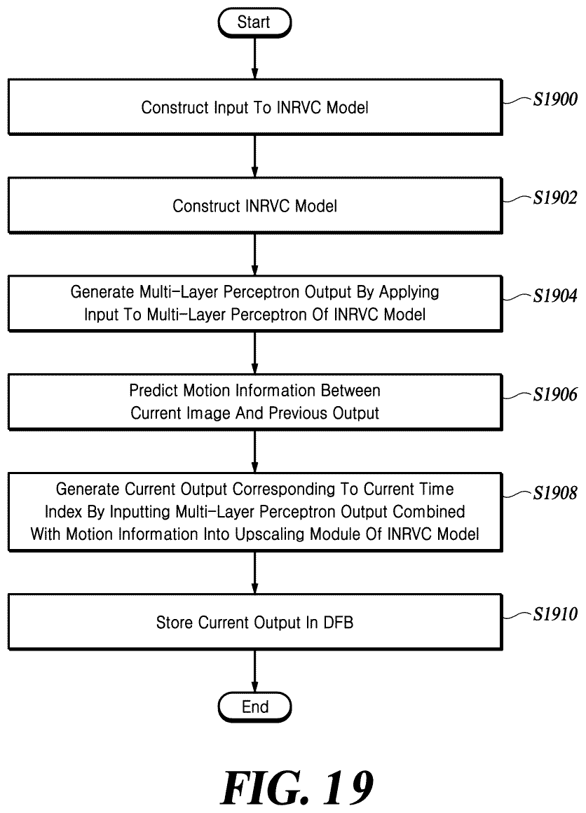

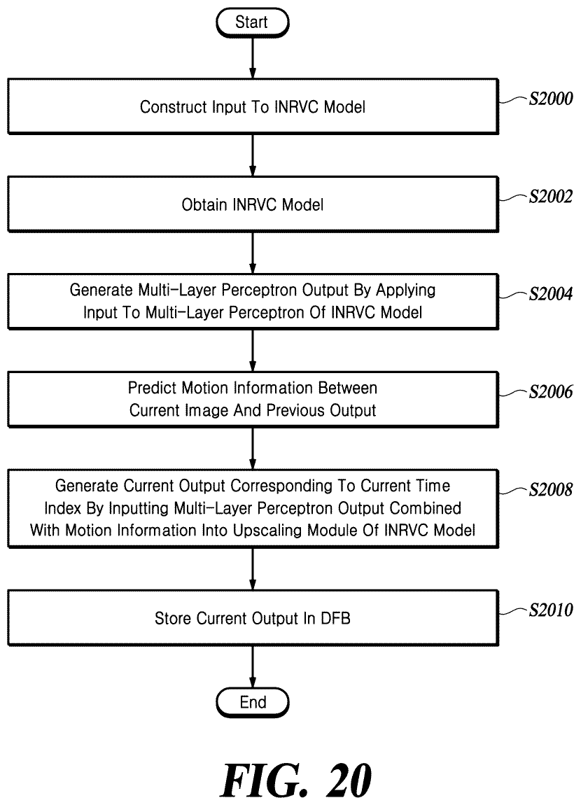

Hereinafter, by using the illustrations of FIGS. 19 and 20, methods of generating a current image or current block by using the INVRC model are described.

FIG. 19 is a flowchart of a method of encoding the current block by the video encoding apparatus, according to at least one embodiment of the present disclosure.

The video encoding apparatus constructs an input to the INRVC model, including the current time index of the current image (S1900).

The video encoding apparatus constructs the INRVC model (S1902). Here, the INRVC model includes a multi-layer perceptron, upscaling modules, and a feature extractor.

As an example, the video encoding apparatus may construct the INRVC model by training it with the input and the original image, i.e., GT image toward minimizing a loss function. Here, the loss function used may be a combination of L1 loss and structural similarity index loss (SSIM loss), as exemplified by the NeRV model.

The video encoding apparatus applies the input to the multi-layer perceptron of the INRVC model to generate a multi-layer perceptron output (S1904).

The video encoding apparatus predicts motion information between the current image and the previous output of the INRVC model corresponding to the previous time index (S1906).

The video encoding apparatus inputs the multi-layer perceptron output combined with the motion information into the upscaling module of the INRVC model to generate a current output corresponding to the current time index (S1908).

The INRVC model generates spatiotemporal information from features transmitted from the upscaling modules by using the feature extractor.

As an example, the INRVC model additionally includes a quality evaluator and an optical flow estimator.

The INRVC model generates the current output and the previous output corresponding to the previous time index. It then uses the OF estimator to estimate the optical flow in respect of the current output and the previous output. The INRVC model uses the estimated optical flow to improve the current output and the previous output. At this time, the INRVC model uses the quality evaluator to calculate the quality of the previous output. When the quality of the previous output is equal to or above a preset threshold, the INRVC model estimates the optical flow. Conversely, when the quality of the previous output is below the preset threshold, the INRVC model skips the optical flow estimation.

As another example, the INRVC model further includes a deformable convolution module.

The INRVC model generates the current output and the previous output corresponding to the previous time index. It then uses the deformable convolution module to generate temporal dependency between the current output and the previous output. Deformable convolution generates an offset from the current output and the previous output and uses the offset as a basis for adaptively adjusting the size of the convolution kernel. The deformable convolution uses the adjusted convolution kernel to generate the temporal dependency between the current output and the previous output.

The video encoding apparatus stores the current output in the DFB (S1910).

When the input to the INRVC model includes only the current time index, the current output corresponds to the reconstructed image of the current frame.

Alternatively, the input to the INRVC model may be constructed as follows. The video encoding apparatus generates local features. Here, the local features are features of the current block or blocks spatio-temporally adjacent to the current block, extracted by a deep learning-based extraction model. The video encoding apparatus constructs the input to the INRVC model to include local features in addition to the current block index and current time index. The video encoding apparatus predicts the motion information of the current block by using the local features. At this time, as the current output, the video encoding apparatus generates the first reconstructed block of the current block, corresponding to the current block index and current time index.

The video encoding apparatus applies the conventional image encoding process to the current block to generate a second reconstructed block.

The video encoding apparatus determines an INRVC utilization flag based on the first reconstructed block and the second reconstructed block. Here, the INRVC utilization flag indicates whether the INRVC model is to be used on a block-by-block basis. From a rate-distortion optimization perspective, the video encoding apparatus determines the INRVC utilization flag. For example, when the first reconstructed block is optimal, the INRVC utilization flag may be determined to be true. Conversely, when the second reconstructed block is optimal, the INRVC utilization flag may be determined to be false. The video encoding apparatus encodes the INRVC utilization flag.

The video encoding apparatus checks the INRVC utilization flag. If the INRVC utilization flag is true, the video encoding apparatus encodes the parameters of the INRVC model according to the encoding pipeline illustrated in FIG. 12. Conversely, if the INRVC utilization flag is false, the video encoding apparatus may encode coding information according to the conventional image encoding process.

FIG. 20 is a flowchart of a method of reconstructing the current block by the video decoding apparatus, according to at least one embodiment of the present disclosure.

The video decoding apparatus constructs an input to the INRVC model, which includes the current time index of the current image (S2000).

The video decoding apparatus obtains the INRVC model (S2002). Here, the INRVC model includes a multi-layer perceptron, upscaling modules, and a feature extractor.

As an example, the video decoding apparatus decodes the parameters of the INRVC model from a bitstream. The video decoding apparatus uses the decoded parameters to construct the INRVC model according to a decoding pipeline, as illustrated in FIG. 13.

The video decoding apparatus applies the input to the multi-layer perceptron of the INRVC model to generate a multi-layer perceptron output (S2004).

The video decoding apparatus predict motion information between the current image and the previous output of the INRVC model corresponding to the previous time index (S2006).

The video decoding apparatus inputs the multi-layer perceptron output combined with the motion information to the upscaling module of the INRVC model to generate a current output corresponding to the current time index (S2008).

The operation of the INRVC model has already been described in relation to the video encoding apparatus, so further detailed explanation is omitted.

The video decoding apparatus stores the current output in the DFB (S2010).

When the input to the INRVC model contains only the current time index, the current output corresponds to the reconstructed image of the current frame.

Alternatively, the input to the INRVC model may be constructed as follows. The video decoding apparatus decodes the INRVC utilization flag from the bitstream. Here, the INRVC utilization flag indicates whether the INRVC model is to be used on a block-by-block basis. If the INRVC utilization flag is false, the video decoding apparatus may generate the reconstructed block of the current block according to conventional image decoding methods. Conversely, if the INRVC utilization flag is true, the video decoding apparatus constructs the input as follows to generate the reconstructed block of the current block.

The video decoding apparatus decodes local features from the bitstream. Here, the local features are latent features of the current block or blocks spatio-temporally adjacent to the current block, extracted by a deep learning-based extraction model. The video decoding apparatus constructs the input to the INRVC model to include the local features in addition to the current block's index and the current time index. The video decoding apparatus uses the local features to predict the motion information of the current block. At this time, as the current output, the video decoding apparatus generates the reconstructed block of the current block, corresponding to the current block's index and the current time index.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

155: entropy encoder
510: entropy decoder
1410: multi-layer perceptron (MLP)
1420, 1440: upscaling module
1430: feature extractor
1450: motion transfer module (MTM)
1460: decoded feature buffer (DFB)
1510: quality evaluator
1520: optical flow estimator (OF estimator)

### CROSS-REFERENCE TO RELATED APPLICATIONS

This application claims priority to and the benefit of Korean Patent Application No. 10-2023-0063866 filed on May 17, 2023, and Korean Patent Application No. 10-2024-0048651, filed on Apr. 11, 2024, the entire contents of each of which are incorporated herein by reference.

What is claimed is:

1. A method for reconstructing a current image by a video decoding apparatus, the method comprising:
configuring an input to an Implicit Neural Representation for Video Coding model (INRVC model) that includes a current time index of the current image;
obtaining the INRVC model that includes a multi-layer perceptron and an upscaling module;
generating a multi-layer perceptron output by applying the input to the multi-layer perceptron;
predicting motion information between the current image and a previous output of the INRVC model corresponding to a previous time index; and
generating a current output corresponding to the current time index by inputting the multi-layer perceptron output and the motion information combined to the upscaling module.

2. The method of claim 1, wherein generating the current output comprises:
generating spatiotemporal information from features transferred from the upscaling module.

3. The method of claim 1, wherein generating the current output further comprises:
generating the current output and the previous output of the INRVC model corresponding to the previous time index;
estimating optical flows of the current output and the previous output; and
upgrading the current output and the previous output by using the optical flows.

4. The method of claim 3, wherein generating the current output further comprises:
calculating a quality of the previous output; and
checking the quality of the previous output,
wherein, when the quality of the previous output is equal to or above a preset threshold, the method proceeds with estimating optical flows.

5. The method of claim 1, wherein generating the current output comprises:
generating the current output and the previous output of the INRVC model corresponding to the previous time index; and
generating a temporal dependency between the current output and the previous output.

6. The method of claim 5, wherein generating the temporal dependency comprises:
generating an offset from the current output and the previous output;
adaptively adjusting a size of a convolution kernel based on the offset; and
generating the temporal dependency between the current output and the previous output by using an adjusted convolution kernel.

7. The method of claim 1, further comprising:
decoding from a bitstream an INRVC utilization flag that indicates whether the INRVC model is to be used on a block-by-block basis; and
checking the INRVC utilization flag,
wherein, when the INRVC utilization flag is true, the method proceeds with configuring the input.

8. The method of claim 7, wherein configuring the input comprises:
decoding, from the bitstream, local features that are latent features of a current block or blocks spatio-temporally adjacent to the current block and are extracted by a deep learning-based extraction model;
storing the local features in a decoded feature buffer; and
configuring the input to include the local features further to an index of the current block and the current time index.

9. The method of claim 8, wherein predicting the motion information comprises:
predicting the motion information of the current block by using the local features.

10. The method of claim 8, wherein generating the current output comprises:
generating a reconstructed block of the current block, the reconstructed block corresponding to the index of the current block and the current time index.

11. A method for encoding a current image by a video encoding apparatus, the method comprising:
configuring an input to an Implicit Neural Representation for Video Coding model (INRVC model) that includes a current time index of the current image;
configuring the INRVC model that includes a multi-layer perceptron and an upscaling module;
generating a multi-layer perceptron output by applying the input to the multi-layer perceptron;
predicting motion information between the current image and a previous output of the INRVC model corresponding to a previous time index; and
generating a current output corresponding to the current time index by inputting the multi-layer perceptron output and the motion information combined to the upscaling module.

12. The method of claim 11, wherein configuring the input comprises:
generating local features that are features of a current block or blocks spatio-temporally adjacent to the current block and are extracted by a deep learning-based extraction model; and
configuring the input to include the local features further to an index of the current block and the current time index.

13. A method of claim 12, wherein generating the current output comprises:
generating a first reconstructed block of the current block, the reconstructed block corresponding to the index of the current block and the current time index.

14. The method of claim 13, further comprising:
generating a second reconstructed block by applying an image encoding process to the current block;
determining an INRVC utilization flag based on the first reconstructed block and the second reconstructed block, the INRVC utilization flag indicating whether the INRVC model is to be used on a block-by-block basis; and
encoding the INRVC utilization flag.

15. The method of claim 14, further comprising:
checking the INRVC utilization flag; and
when the INRVC utilization flag is true, encoding parameters of the INRVC model.

16. The method of claim 12, further comprising:
storing the local features in a decoded feature buffer.

17. The method of claim 11, wherein generating the current output further comprises:
generating spatiotemporal information from features transferred from the upscaling module.

18. A method for providing video data to a video decoding apparatus, the method comprising:
encoding the video data into a bitstream; and
transmitting the bitstream to the video decoding apparatus,
wherein the encoding of the video data comprises:
configuring an input to an Implicit Neural Representation for Video Coding model (INRVC model) that includes a current time index of a current image;
configuring the INRVC model that includes a multi-layer perceptron and an upscaling module;
generating a multi-layer perceptron output by applying the input to the multi-layer perceptron;
predicting motion information between the current image and a previous output of the INRVC model corresponding to a previous time index; and
generating a current output corresponding to the current time index by inputting the multi-layer perceptron output and the motion information combined to the upscaling module.
